(19) United States
(12) Patent Application Publication
(10) Pub. No.: US 2017/0286961 A1
(43) Pub. Date: Oct. 5, 2017

(54) ELECTRONIC FRAUD PREVENTION SYSTEMS AND METHODS

(71) Applicant: MASTERCARD INTERNATIONAL INCORPORATED, Purchase, NY (US)

(72) Inventor: Erica Joann Robeen, Hardin, IL (US)

(21) Appl. No.: 15/084,118

(22) Filed: Mar. 29, 2016

(51) Int. Cl. G06Q 20/40; H04W 12/12; G08B 5/22; G06Q 20/42; G08B 13/22

(52) U.S. Cl. CPC G06Q 20/4016; G06Q 20/42; G08B 13/22; G08B 5/22; H04W 12/12

(57) ABSTRACT

A method, a non-transitory computer readable medium with computer executable instructions stored thereon, and a fraud prevention processor each prevent electronic fraud. An electronic communication is received from a resource via a network and it is determined whether the electronic communication includes a premium amount. When the electronic communication includes the premium amount, a difference between this premium amount and a captured premium amount received from a consumer is determined, and when the difference is greater than a predefined threshold, an alert is generated and sent to the consumer indicating the difference.

### BACKGROUND

Electronic fraud has become increasingly prevalent over the past several years. One area where it is especially prevalent is with regard to the procurement of goods and services. For example, a consumer may remunerate a resource for a product and/or service, such as a meal at a restaurant, using a card or electronic device to initiate an electronic communication. At that time, the consumer may add a premium amount to the indicated sub-total. The resource finalizes the electronic communication by adding the premium amount to the sub-total to form a finalized total amount.

The consumer does not typically receive confirmation of the finalized total amount until at least the following day, or more likely until the end of a processing period for an account associated with the card or electronic device. Thus, the consumer rarely checks whether the correct premium amount was added by the resource to the electronic communication, and is thus unaware of incorrectly entered premium amounts. Where the resource knowingly inflates the premium amount (and thus the finalized total amount) beyond that which the consumer authorized, this is very undesirable for the consumer and may even constitute fraud.

### SUMMARY

In an embodiment, a method prevents electronic fraud. A fraud prevention processor receives, via a network, an electronic communication from a resource. The fraud prevention processor determines whether the electronic communication includes a premium amount. When the electronic communication includes the premium amount, a difference between the premium amount and a captured premium amount received from a consumer is determined, and when the difference is greater than a predefined threshold, an alert is generated and sent to the consumer indicating the difference.

In another embodiment, a non-transitory computer readable medium has computer executable instructions stored thereon. The computer executable instructions are executed by a processor to perform the method of electronic fraud prevention. A fraud prevention processor receives, via a network, an electronic communication from a resource such as a merchant, though embodiments also envision the resource to be a service provider such as a cab driver, or the like. The fraud prevention processor determines whether the electronic communication includes a premium amount. When the electronic communication includes the premium amount, a difference between the premium amount and a captured premium amount received from a consumer is determined, and when the difference is greater than a predefined threshold, an alert is generated and sent to the consumer indicating the difference.

In another embodiment, a fraud prevention processor prevents electronic fraud. The fraud prevention processor includes a processor, and a memory communicatively coupled with the processor and storing machine readable instructions. The machine readable instructions, when executed by the processor, are capable of: receiving, via a network, an electronic communication from a merchant; determining, within the fraud prevention processor, whether the electronic communication includes a premium amount; and when the electronic communication includes the premium amount: determining a difference between the premium amount and a captured premium amount received from a consumer; and when the difference is greater than a predefined threshold, generating and sending an alert to the consumer indicating the difference.

### BRIEF DESCRIPTION OF THE FIGURES

FIG. 1 shows one exemplary system for electronic fraud prevention, in an embodiment.

FIG. 2 shows the fraud prevention processor of FIG. 1 in further exemplary detail, in an embodiment.

FIG. 3 is a flowchart illustrating one exemplary method for electronic fraud prevention, in an embodiment.

FIG. 4 is a flowchart illustrating one exemplary sub-method for premium validation during the method of FIG. 3, in an embodiment.

FIG. 5 is a flowchart illustrating one exemplary method for electronic fraud prevention by interacting with a consumer, in an embodiment.

FIG. 6 shows the premium capture device of FIG. 1 in further exemplary detail, in an embodiment.

### DETAILED DESCRIPTION OF THE EMBODIMENTS

A fraud prevention processor and associated components and processes operate to detect fraud within an electronic communication from a resource, where the electronic communication may include a premium amount. In embodiments, after completing a receipt associated with the procurement of goods or services, a consumer sends the premium amount entered on the receipt to the fraud prevention processor. The fraud prevention processor then automatically validates the electronic communication when it is finalized by and received from the resource, by comparing the premium amount within the resource's electronic communication against the premium amount sent by the consumer. Where the premium amount in the resource's communication is greater than the premium amount received from the consumer, the fraud prevention processor may automatically initiate an arbitration process to resolve the discrepancy. Consequently, embodiments mentioned herein improve and enhance the field of electronic fraud prevention.

Where the consumer has not already provided a premium amount for an electronic communication from a resource that includes a premium amount, the fraud prevention processor sends information of the electronic communication to the consumer, such that the consumer may validate the premium amount within the resource's communication.

The fraud prevention processor operates to improve electronic communication processing by automatically identifying fraud related to a premium amount (e.g., a gratuity or tip) added to an electronic communication indicative of a transaction between the consumer and the resource. (In embodiments, the resource, can be a merchant (as discussed in exemplary fashion below) though can also be a service provider such as a cab driver, or the like.) Such improvement benefits the customer by automatically detecting previously unchecked fraud in electronic communications. By automatically checking premium amounts in electronic communications, such fraud is preventable or at least detectable which allows further action to be taken. When a discrepancy in premium amounts is detected, arbitration between the card association and the merchant, or between the merchant and the consumer, may be automatically started, or initiated by the consumer. The fraud prevention processor improves service of the card association and thereby attracts consumers wishing to have such fraud prevention on future communications to use financial cards of the card association.

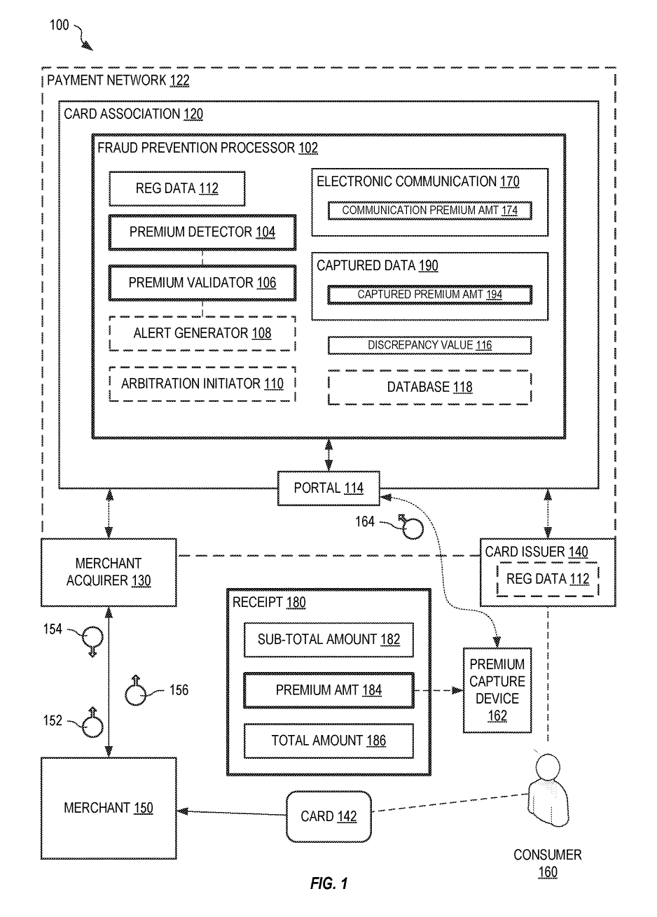

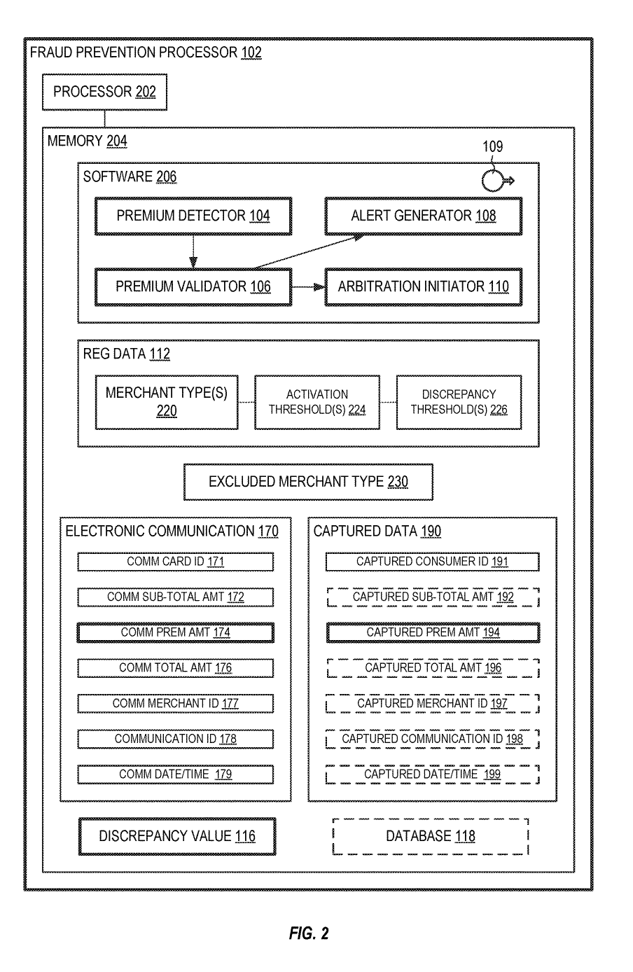

FIG. 1 shows one exemplary system 100 for electronic fraud prevention. FIG. 2 shows a fraud prevention processor 102 of system 100 of FIG. 1 in further exemplary detail. FIGS. 1 and 2 are best viewed together with the following description.

System 100 includes fraud prevention processor 102 that is illustratively shown operating within a card association 120 that is part of a payment network 122. Card association 120 may represent one of: MasterCard®, Visa®, American Express®, and so on, where payment network 122 represents one of the MasterCard® payment network, the Visa® payment network, and the American Express® payment network, respectively. Embodiments shown herein may be used for electronic fraud prevention of four party transactions as handled by MasterCard® and Visa®, and three party transactions as handled by American Express®, for example.

Card association 120, via payment network 122, interacts with a merchant acquirer 130 and a card issuer 140 as found in conventional card processing services.

As shown in FIG. 2, fraud prevention processor 102 includes a processor 202 and memory 204 that illustrate exemplary implementation of fraud prevention processor 102 on a conventional computer server. Memory 204 is illustratively shown storing software 206 having machine readable instructions that are executed by processor 202 to implement functionality of fraud prevention processor 102. Software 206 includes a premium detector 104, a premium validator 106, an alert generator 108 and an arbitration initiator 110. However, processor 202, memory 204, and software 206 may reside (in whole or part) on other servers within card association 120 and/or within merchant acquirer 130 and/or within card issuer 140 without departing from the scope hereof.

A consumer 160 has a financial account with a financial institution (e.g., a bank or credit union—not shown) that is associated with card issuer 140, wherein card issuer 140 issues a card 142 to consumer 160, who may thus be call a cardholder. Card 142 may be a physical card, such as a credit card and a debit card, or may represent an electronic wallet, such as MasterCard® MasterPass® or the like.

Consumer 160 uses card 142 to purchase goods and/or services at a merchant 150, thereby initiating a communication to initiate a financial transaction between merchant 150 and consumer 160 for the purchase. Electronic communication 170 is a data record within memory 204 of fraud prevention processor 102 that contains information of the financial transaction as provided by merchant 150 in the communication. Electronic communication 170 may result from a plurality of distinct steps, including: an authorization request 152 that includes information of card 142 and a sub-total amount sent from merchant 150, via merchant acquirer 130 and payment network 122, to card association 120; an authorization approval 154 that is sent from card association 120, via payment network 122 and merchant acquirer 130 to merchant 150; and a final confirmation 156 that is sent from merchant 150 to card association 120 via merchant acquirer 130 and payment network 122. Card association 120 may interact with card issuer 140 to validate the information within authorization request 152 prior to issuing authorization approval 154.

When paying merchant 150, consumer 160 may add a premium amount 184 (e.g., a gratuity or tip) to a receipt 180, which merchant 150 includes within final confirmation 156. For example, where merchant 150 is a restaurant that provided a meal to consumer 160, upon receiving receipt 180 with authorized payment for a sub-total amount 182, consumer 160 may add premium amount 184 and a total amount 186 to receipt 180 when signing as authorization for the payment. Final confirmation 156, with the corresponding total amount 186, is typically submitted to merchant acquirer 130 sometime after consumer 160 has left the premises of merchant 150. To verify that the correct total amount was entered by merchant 150, one option for consumer 160 is to wait to check the corresponding entry on a statement issued for card 142 against receipt 180. However, consumers often forget or do not bother to check such payments, trusting that the merchant sends final confirmation 156 with the correct premium amount.

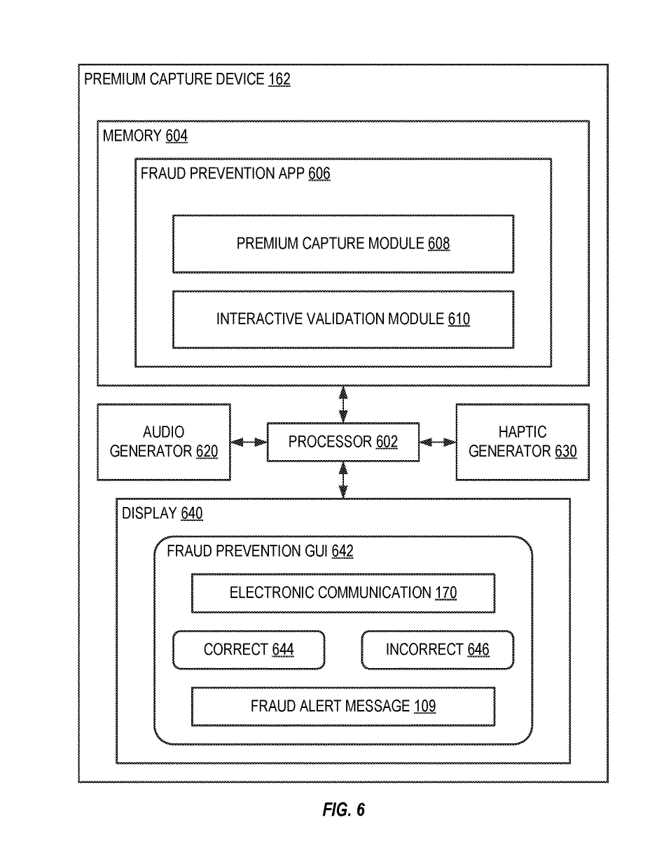

Rather than waiting to check the receipt against a statement, embodiments herein provide that consumer 160 uses a premium capture device 162 to capture premium amount 184, as entered on receipt 180, and then sends a captured premium message 164 containing at least a representation of premium amount 184, to fraud prevention processor 102 via a portal 114. Premium capture device 162 communicates with fraud prevention processor 102 via portal 144 and may use one or more of payment network 122, the Internet, a cellular network, and a wireless network. Fraud prevention processor 102 stores information (e.g., premium amount 184) of captured premium message 164 within captured data 190 (e.g., as captured premium amount 194) as shown. In one embodiment, premium capture device 162 is a smartphone of consumer 160 running a fraud prevention app (see fraud prevention app 606 of FIG. 6) that operates to receive input (e.g., typed, spoken, and/or visual) from consumer 160 containing at least premium amount 184. Premium capture device 162 may represent other similar devices, such as devices selected from the group including: a tablet computer, a personal digital assistant, a notebook computer, and a desktop computer. In certain embodiments, captured premium message 164 is sent from premium capture device 162 to fraud prevention processor 102 as one or more of an email message, a text message, a voice message, and a secure data transfer.

In one example of operation, consumer 160 activates fraud prevention app 606 on premium capture device 162 and speaks a premium amount corresponding to premium amount 184, wherein captured premium message 164 contains a representation of the audio. In another example of operation, consumer 160 activates fraud prevention app 606 on premium capture device 162 and types a value corresponding to premium amount 184, wherein captured premium message 164 contains the value. In another embodiment, consumer 160 operates premium capture device 162 running fraud prevention app 606 to capture an image of receipt 180 when completed with premium amount 184, wherein the captured image may be run through an optical character recognition (OCR) process to determine the premium amount written or typed on the physical receipt.

Premium capture device 162 then sends captured premium message 164 containing the representation (i.e., one of a value, an audio representation, and an image representation) of premium amount 184 to fraud prevention processor 102 via portal 114. Accordingly, as shown in FIG. 2, captured data 190 may include one or more of captured consumer ID 191, a captured sub-total amount 192 (as recognized from the image of receipt 180), captured premium amount 194, a captured total amount 196 (as recognized from the image of receipt 180), a captured merchant ID 197 (as recognized from the image of receipt 180), a captured communication ID 198 (as recognized from the image of receipt 180), and a captured date/time 199 (as recognized from the image of receipt 180). Fraud prevention processor 102 utilizes some or all information within captured data 190 when detecting fraud within electronic communication 170.

Portal 114 is addressable via the Internet for example to allow access by premium capture device 162. In one embodiment, portal 114 is part of card association 120 and/or payment network 122. In another embodiment, portal 114 is part of card issuer 140. In another embodiment, portal 114 is part of merchant acquirer 130.

Card association 120 receives authorization request 152 and final confirmation 156 from merchant 150 via merchant acquirer 130 and payment network 122. Using one or both of authorization request 152 and final confirmation 156, premium detector 104 of fraud prevention processor 102 determines whether electronic communication 170 includes a premium amount. In one embodiment, premium detector 104 determines communication premium amount 174 (i.e., the amount of the premium the merchant has indicated it is entitled to) from final confirmation 156. In another embodiment, premium detector 104 determines communication premium amount 174 by subtracting a sub-total amount of authorization request 152 from a total amount of final confirmation 156.

Fraud prevention processor 102 may also include a list of excluded merchant types 230 corresponding to merchants that do not include premium amounts in electronic communication 170, even though the communication sub-total amount 172 is less than the communication total amount 176. For example, excluded merchant types 230 may include gas station merchant types. In particular, a gas station merchant type sends authorization request 152 and receives authorization approval 154 before gas is pumped, and thus before communication total amount 176 is known. Thus, for gas station merchant types, the difference between communication total amount 176 and communication sub-total amount 172 reflects the cost of the gas beyond the amount (e.g., $1) included in authorization request 152. Thus, gas stations merchant types may be excluded from further processing by fraud prevention processor 102. Merchant types other than gas stations may be excluded for similar reasons. If premium detector 104 determines that communication merchant ID 177 is of a merchant type listed in excluded merchant types 230, then premium detector 104 determines that electronic communication does not include a premium amount.

Where electronic communication 170 includes a premium amount, premium validator 106 within software 206 of fraud prevention processor 102 validates that premium amount with customer 160. In one embodiment, premium validator 106 subtracts captured premium amount 194 (as received/captured from the consumer 160) from communication premium amount 174 (as received from the merchant) to determine a discrepancy value 116. If the discrepancy value is greater than discrepancy threshold 226, fraud prevention processor 102 invokes alert generator 108 to generate and send a fraud alert message 109 to notify consumer 160 of the discrepancy. In one example, discrepancy threshold is zero, such that where communication premium amount 174 is inflated, as compared to captured premium amount 194, premium validator 106 indicates potential fraud. In embodiments, premium validator 106 also invokes arbitration initiator 110 to begin an arbitration process for electronic communication 170 between merchant 150 and consumer 160. Such arbitration for electronic payments relating to card purchases is known in the art and is not described further herein.

Fraud prevention processor 102 implements a service for fraud prevention of premium amounts added to electronic communications. Consumer 160 enrolls, through card issuer 140 and/or card association 120 for example, to use this service. In embodiments, consumer 160 specifies that communications only from certain merchants 150 and/or merchant types 220 (e.g., restaurants, dog groomers, etc.) are to be validated for fraud prevention. Consumer 160 may also define an activation threshold 224 such that only communications having communication premium amount 174 greater than activation threshold 224 are validated. Consumer 160 may also specify a discrepancy threshold 226 such that only communications having a premium discrepancy greater than discrepancy threshold 226 are reported and/or arbitrated. In another embodiment, activation threshold 224 may refer to the total communication amount (e.g., communication total amount 176), such that when electronic communication 170 has a total value less than activation threshold 224, it is not checked for fraud. For example, where activation threshold 224 is set to $10, only communications having a total value (e.g., communication total amount 176) greater than $10 are evaluated for fraud prevention. In one embodiment, discrepancy threshold 226 is defined by card association 120, and in other embodiments the discrepancy threshold is defined by consumer 160. For example, card association 120 may assume responsibility and/or cost for discrepancies less than one dollar, thereby setting discrepancy threshold 226 to the value one such that electronic communication 170 having a discrepancy value 116 less than one dollar do not initiate arbitration.

In one embodiment, where consumer 160 specifies, within merchant types 220, a merchant type (e.g., gas station merchant type) that also appears within excluded merchant types 230, fraud prevention processor 102 issues a warning to consumer 160 indicating that fraud protection for that merchant type is not possible. In an alternate embodiment, where consumer 160 specifies, within merchant types 220, a merchant type (e.g., gas station merchant type) that also appears within excluded merchant types 230, fraud prevention processor 102 overrides the excluded merchant types 230 and implements fraud protection for the specified merchant type.

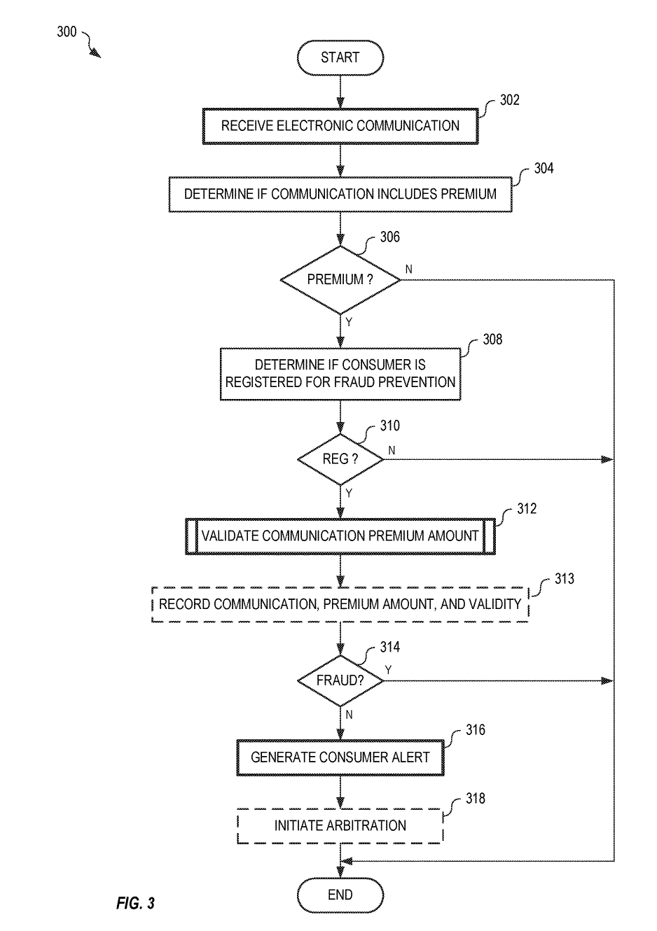

FIG. 3 shows one exemplary method 300 for electronic fraud prevention. Steps 302 through 310 of method 300 are implemented using premium detector 104 of fraud prevention processor 102 of FIGS. 1 and 2 and steps 312 through 318 of method 300 are implemented within premium validator 106, for example.

In step 302, an electronic communication from a merchant 150 is received. In one example of step 302, fraud prevention processor 102 receives authorization request 152 and/or final confirmation 156, or information therefrom and relating to electronic communication 170. In step 304, method 300 determines whether the communication includes a premium amount. In one example of step 304, premium detector 104 subtracts communication sub-total amount 172 from communication total amount 176 to determine communication premium amount 174. When premium detector 104 determines that communication premium amount 174 is greater than activation threshold 224, that the merchant type is included within merchant types 220, and that the merchant type is not included within excluded merchant types 230, then premium detector 104 determines that electronic communication 170 includes a premium amount.

Step 306 is a decision. If, in step 306, method 300 determines that a premium amount is included within electronic communication 170, method continues with step 308; otherwise method 300 terminates.

In step 308, method 300 determines if the consumer is registered for fraud prevention. In one example of step 308, premium detector 104 determines whether consumer 160, identified within electronic communication 170, has associated registration data 112.

Step 310 is a decision. If, in step 310, method 300 determines that consumer 160 is registered for fraud prevention, method 300 continues with step 312; otherwise method 300 terminates.

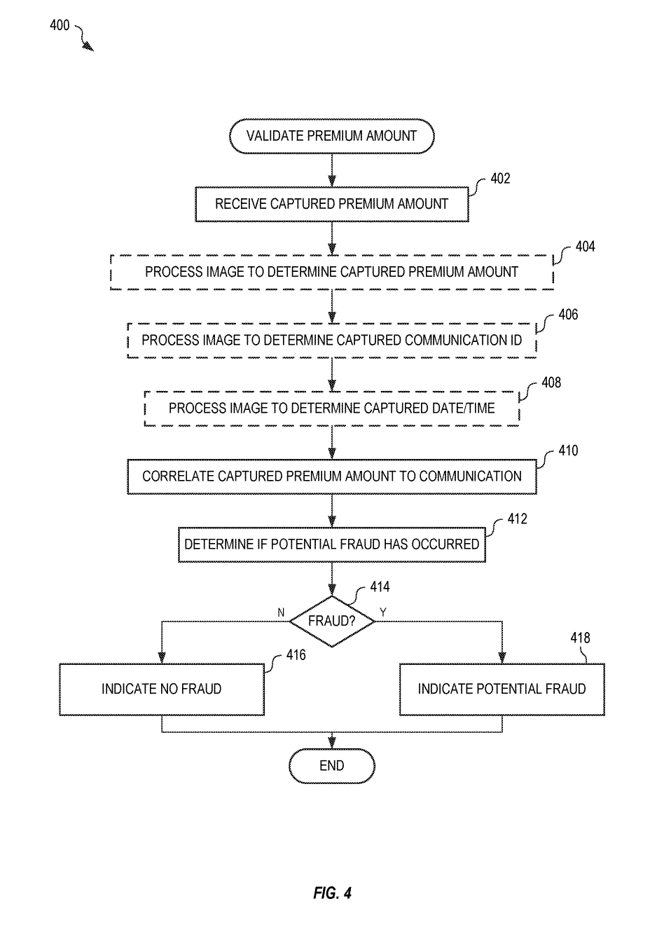

In step 312, method 300 invokes sub-method 400 of FIG. 4 (described below) to validate the premium amount within the electronic communication and identify potential fraud, wherein sub-method 400 returns an indication of validity.

In embodiments, step 313 records the communication, the premium amount, and the validity. In one example of step 313, premium detector 104 records electronic communication 170, communication premium amount 174, and discrepancy value 116 to a database 118.

Step 314 processes a decision. If, in step 314, method 300 determines that the communication is potentially fraudulent, method 300 continues with step 316; otherwise method 300 terminates.

In step 316, method 300 generates a consumer alert. In one example of step 316, premium validator 106 invokes alert generator 108 to send fraud alert message 109 to premium capture device 162 of consumer 160 indicating the discrepancy with communication premium amount 174 and/or communication total amount 176.

In embodiments, step 318 initiates an arbitration process to resolve the discrepancy. In one example of step 318, premium validator 106 invokes arbitration initiator 110 to start conventional payment dispute resolution proceedings (i.e., an arbitration process) between merchant 150 and consumer 160 within card association 120 for electronic communication 170. Method 300 then terminates. Method 300 repeats for each electronic communication 170 (e.g., authorization request 152 and/or final confirmation 156) received within fraud prevention processor 102.

FIG. 4 shows one exemplary sub-method 400 that is invoked from step 312 of method 300, FIG. 3, for validating a premium amount within an electronic communication. Sub-method 400 is implemented within premium validator 106 of fraud prevention processor 102 for example.

In step 402, the premium amount from the consumer is received. In one example of step 402, premium validator 106 receives captured premium message 164, containing information of at least a captured consumer ID 191 and captured premium amount 194, from premium capture device 162 via portal 114.

In the embodiment where premium capture device 162 captures an image of receipt 180 and sends that image within captured premium message 164, steps 404 through 408 can be included to process captured premium message 164. In step 404, sub-method 400 processes the image to determine the captured premium amount. In one example of step 404, premium validator 106 uses OCR to process the image within captured premium message 164 to determine captured premium amount 194. In step 406, sub-method 400 processes the image to determine a communication ID. The communication ID may uniquely identify electronic communication 170 and is typically printed, at least in part, upon receipt 180. In one example of step 406, premium validator 106 uses OCR to process the image within captured premium message 164 to determine captured communication ID 198. In step 408, sub-method 400 processes the image to determine the captured date/time. In one example of step 408, premium validator 106 uses OCR to process the image within captured premium message 164 to determine captured date/time 199.

In the embodiment where captured premium message 164 contains an audio representation of the captured premium amount, premium validator 106 implements steps (not shown) for automatically transcribing the audio to determine captured premium amount 194 and may determine a date/time reference based upon a date and time of the audio recording by consumer 160, wherein that date and time is assumed to correspond to communication date/time 179 of electronic communication 170.

In step 410, sub-method 400 correlates the captured premium amount to the electronic communication 170. That is, upon receiving captured data 190, sub-method 400 determines and/or selects the corresponding electronic communication 170 within card association 120 for validating the premium amount. In one example of step 410, premium validator 106 correlates one or more of captured consumer ID 191, captured merchant ID 197, captured communication ID 198 and captured date/time 199, against one or more of communication card ID 171, communication merchant ID 177, communication ID 178 and communication date/time 179 when matching captured premium amount 194 to electronic communication 170. In another example of step 410, where captured premium message 164 includes captured consumer ID 191 that uniquely identifies consumer 160 and a captured date/time 199, premium validator 106 matches captured consumer ID 191 to communication card ID 171 of electronic communication 170 and matches captured date/time 199 to communication date/time 179 of electronic communication 170. This matching process may involve additional translation steps using database tables within one or both of card association 120 and card issuer 140 to determine a match between captured consumer ID 191 and communication card ID 171 for example, without departing from the scope hereof. In another example of step 410, where captured premium message 164 includes captured communication ID 198, premium validator 106 matches captured communication ID 198 to communication ID 178 of electronic communication 170.

In step 412, sub-method 400 determines if potential fraud has occurred. In one example of step 412, premium validator 106 subtracts captured premium amount 194 from communication premium amount 174 to determine a discrepancy value 116, and if discrepancy value 116 is greater than discrepancy threshold 226, fraud has potentially occurred. That is, premium validator 106 determines whether communication premium amount 174 within electronic communication 170 is greater than captured premium amount 194 of captured data 190, and thereby indicates that electronic communication 170 is potentially fraudulent when electronic communication 170 is greater than captured premium amount 194.

Step 414 processes a decision. If, in step 414, sub-method 400 determines that electronic communication 170 is potentially fraudulent, sub-method 400 continues with step 416; otherwise, sub-method 400 continues with step 418. In step 416, sub-method 400 indicates that there is no fraud to steps 313 and 314 of method 300 and returns control to method 300. In step 418, sub-method 400 indicates potential fraud to steps 313 and 314 of method 300 and returns control to method 300.

Steps 402 through 408 of sub-method 400 may be performed external to premium validator 106, such as when captured premium message 164 is first received within fraud prevention processor 102 or may be performed within other components of system 100, such as within portal 114, without departing from the scope hereof.

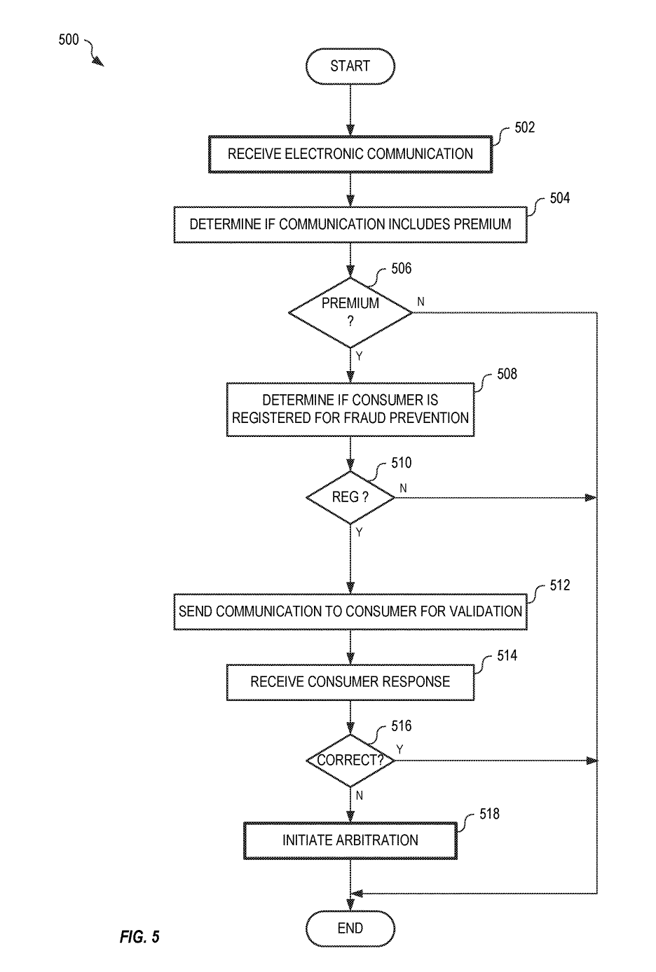

FIG. 5 is a flowchart illustrating one exemplary method 500 for electronic fraud prevention by interacting with consumer 160. Method 500 is for example implemented within premium detector 104 of fraud prevention processor 102 of FIG. 1 and provides an alternative handling of electronic communication 170 when consumer 160 has not sent captured premium message 164.

In step 502, an electronic communication is received. In one example of step 502, fraud prevention processor 102 receives authorization request 152 and/or final confirmation 156, or information therefrom and relating to electronic communication 170. In step 504, method 500 determines whether the communication includes a premium amount. In one example of step 504, premium detector 104 subtracts communication sub-total amount 172 from communication total amount 176 to determine communication premium amount 174. When premium detector 104 determines that communication premium amount 174 is greater than activation threshold 224, that the merchant type is included within merchant types 220, and that the merchant type is not included within excluded merchant types 230, then premium detector 104 determines that electronic communication 170 includes a premium amount.

Step 506 is a decision. If, in step 506, method 500 determines that a premium amount is included within electronic communication 170, method continues with step 508; otherwise method 500 terminates.

In step 508, method 500 determines if the consumer is registered for fraud prevention. In one example of step 508, premium detector 104 determines whether consumer 160, identified within electronic communication 170, has associated registration data 112.

Step 510 is a decision. If, in step 510, method 500 determines that consumer 160 is registered for fraud prevention, method 500 continues with step 512; otherwise method 500 terminates.

In step 512, method 500 sends the communication to the consumer for validation. In one example of step 512, premium detector 104 sends information of electronic communication 170 to premium capture device 162 of consumer 160, wherein consumer 160 views the information and determines whether communication premium amount 174 is correct. For example, consumer 160 may review receipt 180 to determine whether communication premium amount 174 matches captured premium amount 194. In another example of step 512, premium detector 104 sends information of electronic communication 170 via SMS and/or email to consumer 160.

In step 514, method 500 receives the consumer's response. In one example of step 514, consumer 160 interacts with premium capture device 162 to indicate whether electronic communication 170 is correct, entering premium amount 184 if it is not correct, wherein premium capture device 162 sends the response to fraud prevention processor 102 via portal 114. In another example of step 514, consumer sends a SMS and/or email to fraud prevention processor 102 via portal 114 to indicate whether electronic communication 170 is correct or not.

Step 516 is a decision. If, in step 516, method 500 determines that the communication is correct, method 500 terminates; otherwise method 500 continues with step 518. Step 516 may use other conditions, such as one or both of activation threshold 224 and discrepancy threshold 226 based upon a returned value of premium amount 184, when determining whether electronic communication 170 is correct.

In step 518, method 500 initiates arbitration. In one example of step 518, premium detector 104 invokes arbitration initiator 110 to initiate an arbitration process between merchant 150 and consumer 160 for electronic communication 170. As noted above, such arbitration for electronic payments relating to card purchases is known in the art and is not described further herein.

In embodiments where system 100 records electronic communication 170, associated communication premium amount 174, and discrepancies (e.g., discrepancy value 116) from captured premium amount 194 to database 118, system 100 may also provide one or more reports summarizing these electronic communications (e.g., electronic communication 170), premium amounts, and discrepancies occurring within a specified period to consumer 160. For example, system 100 may generate monthly reports summarizing electronic communications, premium amounts, and discrepancy amounts.

FIG. 6 shows premium capture device 162 of FIG. 1 in further exemplary detail. As noted above, premium capture device 162 may represent a smartphone of consumer 160 and includes a processor 602 and memory 604 that have a fraud prevention app 606. Fraud prevention app 606 is for example developed by card association 120 and downloaded by consumer 160 onto premium capture device 162. Fraud prevention app 606 is implemented as machine readable instructions that are executed by processor 602 to provide the functionality of premium capture device 162 described herein.

Fraud prevention app 606 includes a premium capture module 608 that operates to capture at least premium amount 184 of receipt 180 and send captured premium message 164 to fraud prevention processor 102 via portal 114. For example, premium capture module 608 may interact with consumer 160, providing instructions on capturing premium amount 184 from receipt 180.

In certain embodiments, fraud prevention app 606 also includes an interactive validation module 610 that operates to receive electronic communication 170 from fraud prevention processor 102, via portal 114, and display relevant information of electronic communication 170 within a fraud prevention graphical user interface (GUI) 642 on a display 640 of premium capture device 162. Consumer 160 may then select one of a correct button 644 and an incorrect button 646 within GUI 642 to respond to fraud prevention processor 102 regarding the correctness of communication premium amount 174 within electronic communication 170. In certain embodiments, premium capture module 608 receives a message from fraud prevention processor 102 indicating that authorization request 152 has been received from merchant 150 and uses GUI 642 to actively prompt consumer 160 to enter the corresponding premium amount 184. That is, fraud prevention processor 102 may control fraud prevention app 606 to request the premium amount for electronic communication 170 from consumer 160 when it has not already been provided.

In certain embodiments, fraud prevention app 606 displays fraud alert message 109, received from alert generator 108 via portal 114, within GUI 642 to alert consumer 160 to potential fraud within electronic communication 170. In certain embodiment, fraud prevention app 606 may also utilize one or both of an audio generator 620 and a haptic generator 630 of premium capture device 162 to attract the attention of consumer 160 to information displayed within GUI 642.

Changes may be made in the above methods and systems without departing from the scope hereof. For example, although fraud prevention processor 102 is shown implemented within card association 120, fraud prevention processor 102 and/or parts thereof, may be implemented in one or both of merchant acquirer 130 and/or card issuer 140. In certain embodiments, premium detector 104 is implemented within one or more computer servers of merchant acquirer 130 and premium validator 106, alert generator 108 and arbitration initiator 110 are implemented within one or more computer servers of card issuer 140. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for electronic fraud prevention, comprising:
receiving, at a fraud prevention processor and via a network, an electronic communication from a resource;
determining, using the fraud prevention processor, whether the electronic communication includes a premium amount; and
when the electronic communication includes the premium amount:
determining a difference between the premium amount and a captured premium amount received from a consumer; and
when the difference is greater than a predefined threshold, generating and sending an alert to the consumer indicating the difference.

2. The method of claim 1, the step of generating and sending the alert further comprising initiating an arbitration process between the resource and the consumer to resolve the difference.

3. The method of claim 1, wherein the captured premium amount is received via the network from a premium capture device of the consumer.

4. The method of claim 3, further comprising controlling a graphical user interface of the premium capture device to display the alert to the consumer.

5. The method of claim 4, further comprising prompting, via the graphical user interface of the premium capture device, the consumer to enter a value of the premium amount.

6. The method of claim 3, wherein the captured premium amount is received within an image of a receipt corresponding to the electronic communication, the step of determining the difference further comprising recognizing the captured premium amount from the image.

7. The method of claim 3, wherein the premium capture device comprises a fraud prevention app that communicates with the fraud prevention processor via one or more of the network, the Internet, a cellular network, and a wireless network.

8. The method of claim 1, before the step of determining the difference, determining whether the consumer is registered for fraud prevention, wherein the steps of determining the difference and sending are not performed when the consumer is not registered.

9. A non-transitory computer readable medium with computer executable instructions stored thereon executed by a processor to perform the method of electronic fraud prevention, comprising:
receiving, at a fraud prevention processor and via a network, an electronic communication from a merchant;
determining, using the fraud prevention processor, whether the electronic communication includes a premium amount; and
when the electronic communication includes the premium amount:
determining a difference between the premium amount and a captured premium amount received from a consumer; and
when the difference is greater than a predefined threshold, generating and sending an alert to the consumer indicating the difference.

10. The computer readable medium of claim 9, the step of generating and sending the alert further comprising initiating an arbitration process between the merchant and the consumer to resolve the difference.

11. The computer readable medium of claim 9, wherein the captured premium amount is received via the network from a premium capture device of the consumer.

12. The computer readable medium of claim 11, further comprising controlling a graphical user interface of the premium capture device to display the alert to the consumer.

13. The computer readable medium of claim 11, wherein the captured premium amount is received within an image of a receipt corresponding to the electronic communication, the step of determining the difference further comprising recognizing the captured premium amount from the image.

14. The computer readable medium of claim 11, further comprising prompting, via the premium capture device, the consumer to enter the captured premium amount.

15. The computer readable medium of claim 11, wherein the premium capture device comprises a fraud prevention app that communicates with the fraud prevention processor via one or more of the network, the Internet, a cellular network, and a wireless network.

16. The computer readable medium of claim 9, before the step of determining the difference, determining whether the consumer is registered for fraud prevention, wherein the step of determining the difference and sending are not performed when the consumer is not registered.

17. A fraud prevention processor for electronic fraud prevention, comprising:
a processor; and
a memory communicatively coupled with the processor and storing machine readable instructions that when executed by the processor are capable of:
receiving, via a network, an electronic communication from a merchant;
determining, using the fraud prevention processor, whether the electronic communication includes a premium amount; and
when the electronic communication includes the premium amount:
determining a difference between the premium amount and a captured premium amount received from a consumer; and
when the difference is greater than a predefined threshold, generating and sending an alert to the consumer indicating the difference.

18. The fraud prevention processor of claim 17, wherein the captured premium amount is received via the network from a premium capture device of the consumer.

19. The fraud prevention processor of claim 18, further comprising controlling a graphical user interface of the premium capture device to display the alert to the consumer.

20. The fraud prevention processor of claim 18, wherein the captured premium amount is received within an image of a receipt corresponding to the electronic communication, the machine readable instructions, when executed by the processor, being further capable of recognizing the captured premium amount from the image to determine the difference.
